(19) United States
(12) Patent Application Publication
(10) Pub. No.: US 2010/0016022 A1
(43) Pub. Date: Jan. 21, 2010

(54) Methods and Apparatus for Providing Services Information with a Femtocell Wireless Base Station

(75) Inventors: Charles Liu, Chapel Hill, NC (US); Phillip Marc Johnson, Durham, NC (US); William O. Camp, JR., Chapel Hill, NC (US); Jacobus Cornelis Haartsen, Hardenberg (NL); Norbert Donald Ingram, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/179,009

(22) Filed: Jul. 24, 2008

Related U.S. Application Data
(60) Provisional application No. 61/080,866, filed on Jul. 15, 2008.

(51) Int. Cl. H04M 1/00

(52) U.S. Cl. 455/561

(57) ABSTRACT

A femtocell base station is configured to transmit site-specific services data to in-range wireless devices, using a common broadcast channel. The site-specific services data identifies available services including, but not limited to, alternate radio signals available in the vicinity, such as FM radio signals, wireless local-area network (WLAN) signals, and the like; location-related services, including the availability of location beacon signals and/or location assistance data for use in position determination using assisted-GPS technology; and physical resources available to the device user, such as printers, copy machines, vending services, and the like. An exemplary mobile station is configured to extract site-specific services data from the femtocell base station signal, and to access a second radio signal using the site-specific services data. In some embodiments, the second radio signal may comprise a low-power FM radio signal, a wireless local-area network (WLAN) signal, a location beacon, or a radio-navigation signal.

### RELATED APPLICATION

This application claims the benefit of U.S. Provisional Patent Application 61/080866 filed Jul. 15, 2008, which is incorporated herein by reference.

### BACKGROUND

The present invention relates generally to communication systems. More specifically, the invention relates to methods and apparatus for providing information to mobile communication devices using a femtocell base station.

Femtocell base stations, alternatively known as access point base stations, cellular access points, or simply femtocells, are small, short-range cellular base stations designed for use in residential or business environments. These femtocells transmit and receive signals compatible with one or more existing wireless telecommunication standards, such as those promulgated by the 3^{rd}-Generation Partnership Project (3GPP). Thus, data and voice services provided by a femtocell can be accessed by conventional wireless handsets, using the same radio access technology used to connect to conventional base stations.

Unlike conventional base stations, however, femtocells are connected to a wireless service provider's network indirectly, through a broadband data connection such as a digital subscriber line (DSL) or cable connection. Thus, the signaling and “backhaul” between a femtocell and the corresponding wide-area wireless network is carried over a conventional broadband connection, through a public data network such as the Internet.

Current standardization efforts with regards to femtocell base stations are focused on traditional wireless network issues, such as handoffs between femtocells and the wide-area wireless network, mitigation of interference between femtocells, femtocell users, and the wide-area wireless network, processing of emergency calls, and the like. However, less attention is paid to exploiting the fundamentally local nature of femtocells to provide enhanced services to users of wireless devices.

### SUMMARY

In various embodiments of the present invention, a femtocell base station is configured to transmit site-specific services data to mobile stations, using a common broadcast channel. The femtocell base station provides wireless voice and/or data services to the wireless devices according to at least one wireless telecommunication standard, such as the GSM standard or the Universal Mobile Telecommunications System (UMTS) standard developed by 3GPP. Because the femtocell is inherently a “local” device, the site-specific services data can be localized to identify services available to the wireless devices and/or to the device users. These identified services may include, but are not limited to: alternate radio signals available in the vicinity, such as FM radio signals, wireless local-area network (WLAN) signals, and the like; location-related services, including the availability of location beacon signals and/or location assistance data for use in position determination using assisted-GPS technology; and physical resources available to the device user, such as printers, copy machines, vending services, and the like.

Accordingly, an exemplary femtocell base station according to some embodiments of the present invention comprises a radio module configured for wireless communication with one or more mobile stations according to at least one wireless telecommunication standard, a data network interface module operative to provide a data connection between the radio module and a wide-area network, via a local broadband connection, and a configuration module operative to store site-specific services data and to configure the radio module to broadcast the site-specific services data to the one or more mobile stations.

Site-services data transmitted by a femtocell may be received and processed using corresponding portable communications devices and corresponding methods. Thus, an exemplary method for acquiring services information with a portable communications device comprises receiving a wireless telecommunications signal broadcast by a femtocell base station, extracting site-specific services data from the signal, and accessing a second radio signal using the site-specific services data. In some embodiments, the second radio signal may comprise a low-power FM radio signal, a wireless local-area network (WLAN) signal, a location beacon, or a radio-navigation signal, such as a GPS signal.

Of course, those skilled in the art will appreciate that the present invention is not limited to the above contexts or examples, and will recognize additional features and advantages upon reading the following detailed description and upon viewing the accompanying drawings. In particular, the skilled practitioner will appreciate that embodiments of the present invention may include, but are not limited to:

(a) A femtocell base station comprising a radio module configured for wireless communication with mobile stations according to at least one wireless telecommunication standard, a data network interface module operative to provide a data connection between the radio module and a wide-area network, via a local broadband connection, and a configuration module operative to store site-specific services data and to configure the radio module to broadcast the site-specific services data on a common channel to the mobile stations.

(b) A femtocell base station as in (a), wherein the site-specific services data comprises at least one of: radio signal data identifying one or more alternate radio signals; position data indicating a location of the femtocell base station; location assistance data for use by a mobile station in determining its position; and resource data identifying one or more physical resources in the vicinity of the femtocell base station.

(c) A femtocell base station as in (a), wherein the site-specific services data comprises beacon data identifying one or more location beacon signals.

(d) A femtocell base station as in (c), wherein the beacon data comprises color code information and corresponding position information for each of the one or more location beacon signals.

(e) A femtocell base station as in (a), wherein the configuration module is further operative to encrypt at least a portion of the site-specific services data for broadcasting.

(f) A femtocell base station as in (a), wherein the configuration module is further operative to receive a request for site-specific services information from a first mobile station, via the radio module, and to configure the radio module to broadcast the site-specific services data responsive to said request.

(g) A method for acquiring services information with a portable communications device, comprising receiving a wireless telecommunications signal broadcast by a femtocell base station, extracting site-specific services data from the signal, and accessing a second radio signal using the site-specific services data.

(h) A method as in (g), wherein the second radio signal comprises one of a low-power FM radio signal, a wireless local-area network signal, a location beacon, and a radio-navigation signal.

(i) A method as in (g), wherein the second radio signal comprises a location beacon, further comprising determining a position for the portable communications device using the location beacon.

(j) A method as in (i), wherein the site-specific services data includes a color code for the location beacon and location data for the location beacon, and wherein determining a position for the portable communications device using the location beacon comprises identifying the location beacon from two or more beacon signals using the color code.

(k) A method as in (i), wherein accessing the location beacon comprises searching for the location beacon during one or more intervals synchronized to a characteristic cycle of the wireless telecommunications signal.

(l) A method as in (k), wherein the characteristic cycle comprises a paging frame interval.

(m) A method as in (g), further comprising selecting the second radio signal from two or more radio signals identified by the site-specific services data.

(n) A method as in (m), wherein selecting the second radio signal comprises determining a priority value for each of the two or more radio signals based on prior attempts to access the two or more radio signals, and selecting the second radio signal based on the priority values.

(o) A method as in (g), wherein the site-specific services data comprises resource data identifying physical resources in the vicinity of the femtocell, further comprising displaying at least a portion of the resource data to a user of the portable communications device.

(p) A method as in (g), wherein at least a first portion of the site-specific services data is encrypted, further comprising decrypting said first portion using a pre-determined decryption key.

(q) A method as in (g), further comprising sending a request for site-specific services data to the femtocell base station.

(r) A portable communications device, comprising a first radio section configured to receive a wireless telecommunications signal broadcast by a femtocell base station, a second radio section, and a control processor configured to extract site-specific services data from the wireless telecommunications signal and to control the second radio section to access a second radio signal, using the site-specific services data.

(s) A portable communications device as in (r), wherein the second radio signal comprises one of a low-power FM radio signal, a wireless local-area network signal; a location beacon; and a radio-navigation signal.

(t) A portable communications device as in (r), wherein the second radio signal comprises a location beacon, and wherein the control processor is further configured to determine a position for the portable communications device using the location beacon.

(u) A portable communications device as in (t), wherein the site-specific services data includes a color code for the location beacon and location data for the location beacon, wherein the control processor is configured to determine a position for the portable communications device by identifying the location beacon from two or more beacon signals using the color code.

(v) A portable communications device as in (t), wherein the control processor is configured to access the location beacon by searching for the location beacon during one or more intervals synchronized to a characteristic cycle of the wireless telecommunications signal.

(w) A portable communications device as in (v), wherein the characteristic cycle comprises a paging frame interval.

(x) A portable communications device as in (r), wherein the control processor is configured to select the second radio signal from two or more radio signals identified by the site-specific services data.

(y) A portable communications device as in (x), wherein the control processor is configured to select the second radio signal by determining a priority value for each of the two or more radio signals, based on prior attempts to access the two or more radio signals, and selecting the second radio signal based on the priority values.

(z) A portable communications device as in (r), further comprising a display device, wherein the control processor is further configured to determine that the site-specific services data comprises resource data identifying physical resources in the vicinity of the femtocell and display at least a portion of the resource data, using the display device.

(aa) A portable communications device as in (r), wherein the control processor is further configured to decrypt at least a portion of the site-specific services data using a pre-determined decryption key.

(bb) A portable communications device as in (r), wherein the control processor is further configured to send a request for site-specific services data to the femtocell base station.

### BRIEF DESCRIPTION OF THE DRAWINGS

FIG. 1 illustrates a communication system according to one or more embodiments of the present invention.

FIG. 2 is a block diagram illustrating an exemplary embodiment of a femtocell according to the present invention.

FIG. 3 illustrates various services for which site-specific services information may be transmitted according to some embodiments of the present invention.

FIG. 4 is a logic flow diagram illustrating an exemplary method for acquiring services information with a portable communications device.

FIG. 5 is another logic flow diagram, illustrating an exemplary process for accessing a second radio signal using site-specific services data received from a femtocell base station.

FIG. 6 is a logic flow diagram illustrating the determination of a mobile device's position based on a location beacon signal.

FIG. 7 is a block diagram illustrating an exemplary mobile communication device according to some embodiments of the invention.

### DETAILED DESCRIPTION

The present invention is described below in reference to a wireless telecommunication system providing voice and/or data services to a mobile device. Various systems providing voice and data services have been deployed, from 2^{nd}-generation systems such as GSM (providing circuit-switched communications) and GPRS (providing packet-switched communications) to 3^{rd}-generation systems such as the Universal Mobile Telecommunication System (UMTS) standardized by the 3^{rd}-Generation Partnership Project (3GPP). Still other systems are currently under development. These systems may employ any or several of a number of wireless access technologies, such as Time Division Multiple Access (TDMA), Code Division Multiple Access (CDMA), Frequency Division Multiple Access (FDA), Orthogonal Frequency Division Multiple Access (OFDMA), and so on, and one or more multiplexing techniques, including Time Division Duplex (TDD), and Frequency Division Duplex (FDD). Although much of the current interest in femtocell base stations is focused on UMTS solutions, the present invention is not limited to any specific type of wireless communication network or access technology. Indeed, those skilled in the art will appreciate that the network standards and network configurations discussed herein are only illustrative.

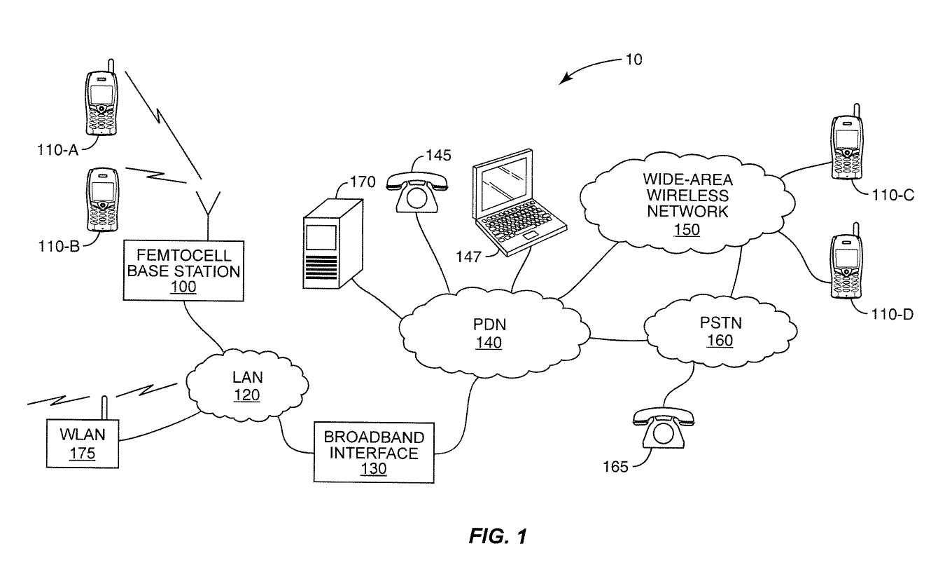

One such illustrative network configuration is presented in FIG. 1, which depicts an exemplary communication system 10, including a femtocell base station 100. Femtocell 100 provides service to several mobile stations 110. Femtocell 100 is associated with wide-area wireless network 150, and provides voice and/or data connections for mobile stations 110-A and 110-B to the wireless network 150 via wireless local-area network (WLAN) 120, broadband interface 130, and public data network (PDN) 140, which may be the Internet. Wireless network 150 and PDN 140 are in turn connected to Public Switched Telephone Network (PSTN) 160. Wireless devices 110-A and 110-B can thus communicate with each other and with various other devices through any of these networks, including such devices as mobile stations 110-C and 110-D, voice-over-Internet-Protocol (VoIP) telephone 145, personal computer 147, and conventional land-line phone 165. As shown in FIG. 1, wireless devices 110 also have access to data server 170 via the PDN 140; data server 170 may be configured to provide access through PDN 140 to a variety of data or applications.

Communication devices 110 may be cellular telephones, personal digital assistants (PDA), communicators, computer devices, or the like, and may be compatible with any of a variety of communications standards, such as the Global System for Mobile Communications (GSM) or one or more of the standards promulgated by 3GPP. Mobile stations 110 might each include a digital camera, for capturing still and video images, and may also include a digital sound recorder and digital music player application. Mobile stations 110 may also support various applications in addition to voice communications, such as e-mail, text messaging, picture messaging, instant messaging, video conferencing, web browsing, and the like. In some embodiments, mobile stations 110 may also include a wireless local-area network (WLAN) transceiver configured for communication with WLAN access point 175. WLAN access point 175 is also connected to PDN 140, via LAN 120 and broadband 130, potentially providing communication devices 110 or other wireless devices with alternative connectivity to Internet-based resources such as data server 170. Although illustrated in FIG. 1 as separate units, femtocell base station 100 and WLAN access point 175 may be integrated into a single unit, in some embodiments.

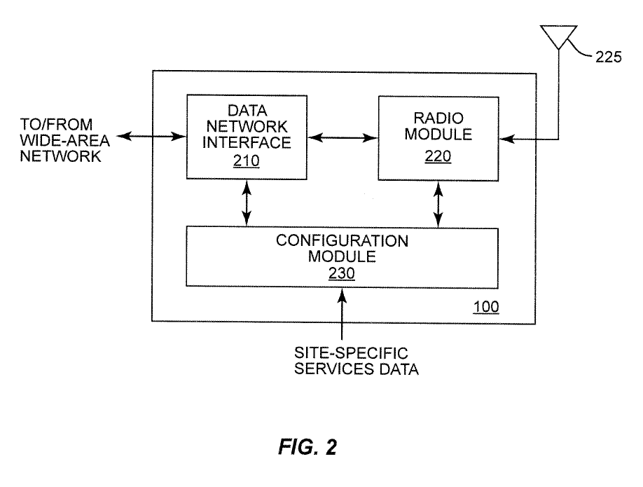

FIG. 2 illustrates functional blocks of a femtocell base station 100, including a data network interface 210, a radio module 220, and a configuration module 230. The data network interface 210 provides radio module 220 with connectivity to a wide-area network, such as wide-area wireless network 150, through a locally available broadband connection. Data network interface 210 may comprise a standard local-area network interface, such as an Ethernet interface or a wireless LAN interface, for connectivity to a local-area network with broadband data access, such as via a digital subscriber line (DSL) or cable modem connection. In some embodiments, data network interface 210 may be configured so that femtocell 100 may be connected directly to the broadband interface 130—in these embodiments, for example, data network 210 may comprise cable modem or DSL modem functionality.

Radio module 220 is compatible with one or more wireless telecommunications standards, such as GSM or UMTS, and may thus communicate with compatible mobile stations 110 via antenna 225. Radio module 220 comprises transmitter and receiver circuitry similar to that in full-size base stations for the same wireless standard, except that the transmitter power for femtocell 100 is limited, and the number of mobile stations 110 that can simultaneously be supported may be limited. Although transmitted at low power, the signals transmitted by radio module 220 are similar to those transmitted by a corresponding wide-area wireless network, such as wireless network 150 in FIG. 1. Thus, handsets normally serviced by wireless network 150 may also receive voice and/or data services from femtocell base station 100, using the same radio access technology.

Configuration module 230, which may comprise one or more microprocessors, microcontrollers, or the like, configured with appropriate software, controls the operation of data network interface 210 and radio module 220. In particular, configuration module 230 controls the transmission by radio module 220 of site-specific services data on one or more common broadcast channels. Thus, configuration module 230 facilitates the “localization” of broadcast transmissions by femtocell base station 100. Configuration module 230 may receive the site-specific services data via a local interface, or remotely, via data network interface 210. Thus, in some embodiments, femtocell 100 may be connected directly to a keyboard, display screen, and/or other user interface devices (not shown), allowing a user to provide configuration data directly to configuration module 230. In such embodiments, configuration module 230 may comprise a configuration application program for facilitating the entry of the configuration data, including site-specific services data. Once entered, the configuration data may be stored in non-volatile memory (not shown) for future use in configuring and operating radio module 220. Alternatively, site-specific services data and other configuration data may be provided from a remote source and stored. In one such embodiment, configuration data for femtocell 100 may be stored remotely and downloaded upon initialization and/or power-up of femtocell 100. In still other embodiments, configuration module 230 may be configured to provide a web server interface, allowing a remotely located user to enter configuration data, via a web browser or other application program, for storage and use at the femtocell 100. Any of these embodiments, particularly the latter, may further include appropriate security mechanisms, such as an authentication process, to ensure that configuration data are entered by only authorized personnel.

In some embodiments, femtocell 100 may be configured to ensure that only authorized users are able to receive the broadcasted site-specific services information. In these embodiments, configuration module 230 may encrypt all or a portion of the site-specific services data before it is broadcasted, using any suitable encryption algorithm and an encryption key. In these systems, authorized mobile stations 110 must possess a corresponding pre-determined decryption key (which is identical to the encryption key if symmetric encryption is used). In some cases, the decryption key may be distributed to authorized mobile stations by a system operator well before any attempt to access the site-specific services data. For example, a building manager might distribute a passcode, consisting of a text string, to device owners, for entry into their mobile devices. In other cases, the decryption key may be provided to a device by the base station on an as-needed basis. For instance, the decryption key may be provided in response to or as part of an authentication process conducted between the mobile station and the femtocell, or in response to an authenticated request from a mobile station for site-specific services data.

In some embodiments, femtocell 100 is configured to transmit the site-specific services data periodically and continuously, on a common broadcast channel. In these systems, mobile stations can access site-specific services data immediately upon acquiring the femtocell's signal. In other embodiments, femtocell 100 may be configured instead to transmit the site-specific services data on demand. In these systems, configuration module 230 is configured to process a request for site-specific services data received from a mobile station and to configure the radio module 220 to broadcast the site-specific services data responsive to the request. In some embodiments, the site-specific services data may be transmitted only a single time, in response to a request, while in others it may be repeated a pre-determined number of times or for a pre-determined period of time. In some embodiments, the site-specific services data may be tailored to a particular request, while in others all available site-specific services data is broadcast.

In any event, the transmitted site-specific services data identifies and/or characterizes one or more locally available services. These services may include wireless services, physical resources, or a combination of both. Because a femtocell is typically configured to cover a small physical area, such as a single residence or small business, or a single floor or wing of a building, the site-specific services data may be highly customized to the location served by the femtocell.

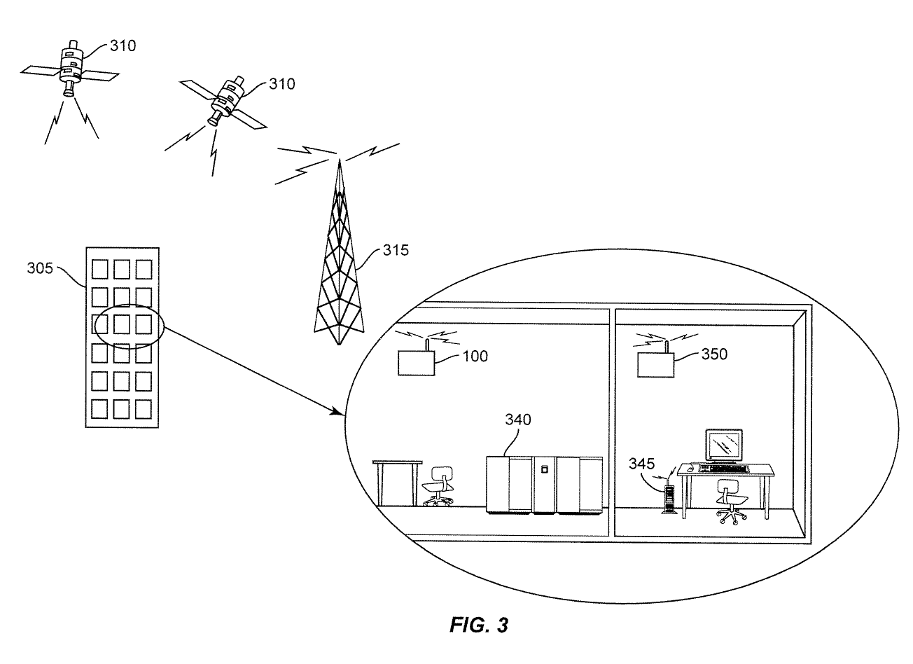

An exemplary deployment scenario for a femtocell 100 is illustrated in FIG. 3. In this scenario, femtocell 100 is deployed on a middle floor in an office building 305, providing voice and/or data services to mobile stations in the vicinity. Site-specific services data transmitted by femtocell 100 may include data identifying or characterizing various radio signals available to a wireless device, such as signals from broadcast tower 315, radio-navigation signals from Global Positioning System (GPS) satellites 310, and wireless access points 345 and 350.

Site-specific services data might also include information identifying other resources available in the vicinity, such as the availability of office printer 340, or networked computer 345. In some embodiments, site-specific services might indicate that coffee service is available in a particular room or floor, or specify the location of copy machines or vending machines. Information regarding other services in the proximity of the femtocell, including commercial services (e.g., shops), or public services (e.g., post office, museums, etc.) may also be transmitted.

As suggested above, site-specific services data may comprise data identifying one or more alternate radio signals available at or near the femtocell's location. These radio signals may include FM radio stations (conventional, high-power radio stations as well as low-power, unlicensed stations), wireless local-area network signals, alternative wireless telecommunication signals, location beacon signals, etc. For example, a building operator may maintain a low-power FM radio transmission to provide information and/or entertainment to the building's occupants. Broadcasting information identifying the low-power FM station on a femtocell broadcast channel provides a convenient way to allow portable devices to “discover” the availability of this service, and to provide information about this service to the device user. The services information for the low-power FM radio signal may include frequency information as well as other information describing the content of the signal. Those skilled in the art will appreciate that similar services information may be provided for other radio signals. For instance, services data for any of a variety of available radio services may include channel numbers, transmission frequencies, service set identifiers (SSIDs), MAC addresses, timing information (for synchronization purposes), or the like, as well as text information describing the available service.

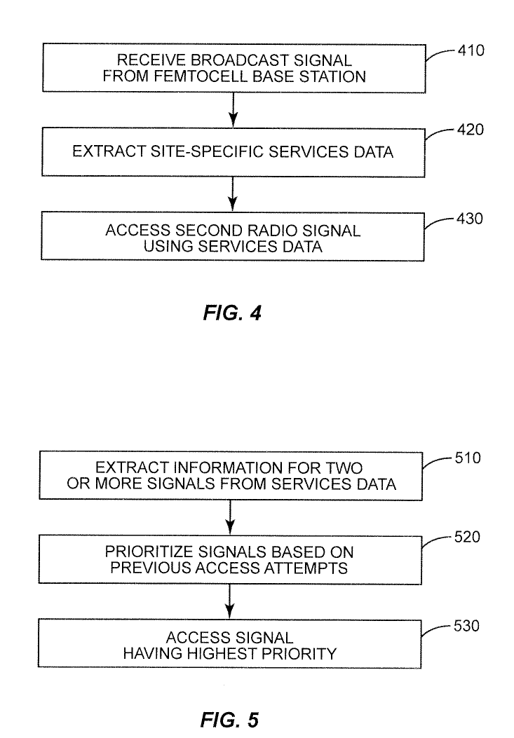

Site-specific services data that identifies a second radio signal may be used by a receiving wireless device to automatically access the second radio signal, or to assist the user of the device in accessing the signal. A logic flow diagram illustrating such a process is provided in FIG. 4. As shown at block 410, a mobile station receives a broadcast signal from a femtocell base station. The broadcast signal includes site-specific services data, which the mobile station extracts from the broadcast signal, as shown at block 420. At block 430, the mobile station uses the services data, which in this embodiment identifies a second radio signal, to access the second radio signal. For instance, frequency information or channel information may be used to tune a receiver to the second radio signal. Timing or synchronization information may be used to acquire or “lock on” to the radio signal.

As was noted above, site-specific services data may be transmitted continuously from some femtocells. In others, however, site-specific services data might only be transmitted on demand. In such a case, a mobile station sends a request for site-specific services data to the femtocell base station before conducting the above procedure. In some cases, the request may identify one or more types of needed services data, so that the data transmitted by the femtocell may be customized. Further, all or a portion of the site-specific services data may be encrypted, to restrict its use to authorized mobile stations. In this case, an authorized mobile station simply decrypts the encrypted data, using a pre-determined decryption key. An unauthorized mobile station is unable to make use of the encrypted data.

This general method may be applied to any of a variety of radio signals, including FM radio signals, WLAN signals, and the like. An advantage of this approach is that time-consuming and power-consuming scanning procedures can be avoided. Mobile stations are typically designed to operate with very low power consumption when in idle mode and receive-only modes; a femtocell broadcast identifying the specific frequencies for other signals may thus be received very efficiently.

One application of the general approach described above is to provide a mobile station with information regarding available location beacons, which may be used to determine a position for the mobile station. This can be particularly important in indoor environments, such as inside an office building, where access to GPS signals or triangulation signals from cellular-based positioning systems may be limited. A mobile station receives site-specific services data from the femtocell, the services data including beacon data indicating the availability of one or more location beacon signals. The location beacon signals may be stand-alone signals, or may be signals “piggybacked” onto low-power FM radio signals, WLAN signals, or the like. The mobile station then tunes to a location beacon signal, using the information provided in the site-specific services data, and obtains the location information. In such an embodiment, the services data for the location beacon may identify a type of signal, a channel number or frequency, timing information, or the like. In some embodiments, timing information may be indexed to a particular characteristic of the femtocell's transmission. For instance, timing information for the location beacon may be referenced to a characteristic cycle of the femtocell transmission, such as a paging-frame interval. This approach allows the time spent searching for or synchronizing to the second radio signal to be minimized.

In some embodiments, the site-specific services data transmitted by the femtocell could list all BSSIDs (Basic Service Set ID) or MAC addresses of the WLAN access points on several floors of an office building, for example. The site-specific services data may further include location information identifying the location of these access points using, for instance, geographic coordinates (latitude, longitude, altitude) or other designators (e.g., “Floor 1”, “Floor 2”, “Basement”, etc.). In these embodiments, after detecting a BSSID or MAC address, the mobile station can determine its approximate position from the corresponding location information. Similarly, location beacons can be based on FM or Bluetooth transmitters. In some embodiments, these beacons can be configured to broadcast location data. Thus, once the beacon signal is acquired, with the aid of the site-specific services data, the mobile station can determine its location by decoding the broadcasted location.

As was noted above, the site-specific services data transmitted by a femtocell can also include resource data informing a mobile station about physical resources or commercial or public services that are available in the vicinity. In some embodiments, this resource data may include specific location, such as a room number or floor number. In these embodiments, the information may be “filtered” based on specific position information for the receiving mobile station. For example, in some embodiments, once the floor is detected by one of the above described location methods, the user can be presented with a list of services for that floor, via the mobile station's display.

In some cases, femtocell 100 may include or have direct access to a GPS receiver—in this case the site-specific services data transmitted by femtocell 100 might include position data, identifying the location of the femtocell, or assistance information for use by a wireless device in acquiring GPS signals. This assistance information may include information indicating which satellite signals should be available, timing information for those signals, satellite ephemeris data, so that a position can be calculated without decoding the radio navigation signal itself, etc. Those skilled in the art will appreciate that such assistance data will allow a properly programmed GPS receiver to more quickly find attenuated GPS signals, with significantly greater signal sensitivity. In these embodiments, the mobile station might estimate its own location based on this broadcasted location information and/or assistance information. For example, a specific floor might be estimated based on the attenuation of the signal received from the femtocell. In some embodiments, the mobile device may be configured to keep track of signal level and the latest estimate of which floor the device is on. To improve the accuracy of the floor estimate, some embodiments of the mobile device may further include an accelerometer, which can be used to track which floor the user is on relative to the level of the RF signal based on previous “known” locations and dead-reckoning techniques.

In some embodiments, a femtocell 100 may be configured to broadcast information identifying one or more WLAN signals available in the femtocell's proximity. In these embodiments, the site-specific services data may further comprise timing information, authentication data, and the like, to facilitate “roaming” and handovers between the femtocell 100 and the WLAN. In some of these embodiments, configuration information for the WLAN may be provided through the configuration interfaces described earlier. In other embodiments, however, the femtocell 100 may be connected to the WLAN, such as through a network controller, and may receive configuration information for the WLAN via that connection. In still other embodiments, the femtocell 100 may include or be associated with a WLAN receiver for monitoring WLAN transmissions and indirectly determining one or more WLAN configuration parameters. In some embodiments, handover to a WLAN or between WLAN access points may be further facilitated by means of communication between the mobile station and femtocell and ultimately the network controller. In some of these embodiments, the mobile station may report its current location to the femtocell 100. The femtocell 100, which is configured to keep track of the handover options, communicates those options to the mobile terminal. When the mobile station loses contact with a given radio bearer, it can then quickly scan those options and reconnect. With enough information, the terminal should be able to approach seamless handovers in the WiFi world without having to use 802.11f (designed for handover). This is particularly helpful for the 100 million access points already in the field that do not support 802.11f.

Further embodiments of the systems and methods disclosed herein include systems for providing positioning information through multiple wireless radio bearers, such as Bluetooth beacons, one or more FM radio signals, a WLAN signal, the Femtocell signal, etc. For instance, some mobile stations may be equipped with a GPS receiver. When the GPS signal fades as the user moves indoors, these mobile devices can access one or several of the available radio bearers (depending, of course, on whether the mobile device includes a compatible receiver) to obtain location information. The location information may include position data for the beacon itself, in some embodiments, as discussed above. In other embodiments, the location information received from one or more beacons may include assistance information for use in acquiring a radio-navigation signal, such as a GPS signal. This assistance information may include information indicating which satellite signals should be available, timing information for those signals, satellite ephemeris data, so that a position can be calculated without decoding the radio navigation signal itself, etc. Those skilled in the art will appreciate that such assistance data will allow a properly programmed GPS receiver to more quickly find attenuated GPS signals, with significantly greater signal sensitivity.

In some embodiments, a mobile station may establish a priority list for available location beacon signals (or other radio signals). In some of these embodiments, beacon signals detected most successfully or most frequently in the past are given the highest priority. Given that past attempts indicate the probability of current success, this approach will generally reduce the need for the mobile device to scan through all available beacon signals and will thus save power. The list is dynamic and can be updated based on the success of detecting a beacon system.

FIG. 5 illustrates a logic flow diagram for a method of signal access in which the above prioritization scheme is applied to signals identified by site-specific services data transmitted by a femtocell. As shown in block 510, information for two or more signals is extracted from the site-specific services data broadcast by a femtocell. As noted above, these signals may comprise location beacons, in some embodiments, but may also comprise signals for other uses. In any event, as shown at block 520, the receiving mobile station prioritizes these signals, based at least in part on previous access attempts. In some embodiments, signals accessed most frequently in the past are assigned values indicating the highest priority. In other embodiments, successes and failures in previous attempts to access these signals are tracked—those signals corresponding to the highest success rates (or lowest failure rates) are given priority values indicating the highest priority. In block 530, the signal having the highest priority is accessed, by tuning an appropriate receiver in the mobile device using the information (e.g., channel number, frequency, etc.) provided in the site-specific services data.

In some embodiments of the invention, site-specific services data provided by a femtocell may include synchronization or other timing information for one or more radio signals, which may be used to further reduce power consumption of mobile devices seeking to access these signals. For instance, a mobile device attempting to collect location information potentially sent in beacons from multiple radio bearers, might normally need to stay “on” for an extended period of time in order to acquire and synchronize with beacons from multiple bearers. In some embodiments, transmissions from each of the location beacons, whether Bluetooth beacons, WLAN beacons, or the like, may be synchronized to the femtocell system, such as to the femtocell paging cycle. Alternatively, the beacons may be synchronized to transmissions of the nearest macrocell. In these systems, a mobile device can listen or search for any type of beacons (BT, WLAN etc.) only during the burst period that occurs coincident with local cellular page frame. Therefore, the radio on-time on the device will be minimized.

In an alternative approach, one or more of the location beacon signals are not synchronized with the femtocell base station transmissions. Instead, the site-specific services data may include timing information indicating a time offset between a particular beacon signal and the femtocell signal. The receiving mobile device can use this timing offset information to reduce acquisition time, thus saving power.

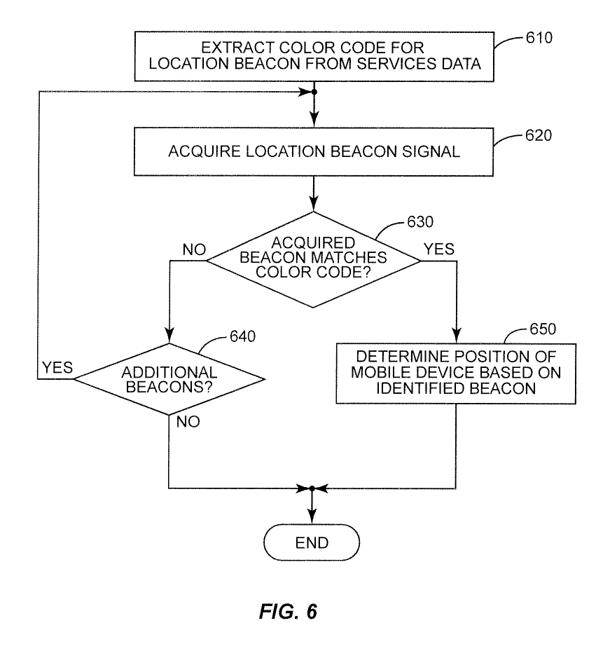

As was discussed earlier, location beacons can be based on various radio signals, including FM, Bluetooth, or wireless LAN signals. In some embodiments, one or more of these beacons may be configured to send a simple code, such as a color code. Once installed, a beacon transmitting a particular code is associated with a particular location, such as a specific floor. The color code for one or more of these location beacons is then transmitted by a nearby femtocell as part of the site-specific services data, along with the corresponding location information. In these embodiments, a mobile station that acquires the location beacon signal can simply match the color code for the received location beacon signal to the transmitted location information to determine its approximate position. An example implementation of this process is illustrated in the logic flow diagram of FIG. 6. As shown at block 610, color code data for one or more location beacons is extracted from the site-specific services data transmitted by the femtocell. At block 620, a location beacon signal is acquired, and its color code detected. Those skilled in the art will appreciate that a color code may comprise a short data word, e.g., 3 or 4 bits, transmitted repetitively. In some cases, the color code may correspond to a specific field of a multi-field data transmission by the location beacon. In some embodiments, the color code may comprise an identification signal or other unique (within a given area) signal transmitted by the location beacon.

In any case, the color code detected from the acquired beacon signal is compared with the one or more color codes extracted from the site-specific services data, as shown at block 630. If it doesn't match, then the mobile station doesn't have location data for that particular beacon. In this case, the mobile station checks to see if additional beacons should be available, as shown at block 640. If so, then the acquisition process repeats at block 620. If not, the process ends.

If the acquired color code does match a color code extracted from the site-specific services data, on the other hand, then the position of the mobile device is determined, based on the identified beacon, as shown at block 650. As was described earlier, the site-specific services data may include position information for each beacon signal along with the color code information. In these embodiments, the mobile device may estimate its position to be the same as the position data for the beacon. In embodiments where multiple short-range beacons are deployed, this estimate may be more than adequate for purposes such as enhanced-911 (E911), etc.

As discussed earlier, because a femtocell transmits a signal compatible with at least one wireless telecommunications standard, conventional handsets and other mobile stations compatible with that standard can receive voice and/or data services from the femtocell. Mobile stations modified according to one or more embodiments of the current invention can exploit the site-specific services data described above, as well. In particular, such a mobile station may be configured to extract site-specific services data included in a wireless telecommunications signal broadcast by a femtocell base station, and to access a second radio signal, using the site-specific services data.

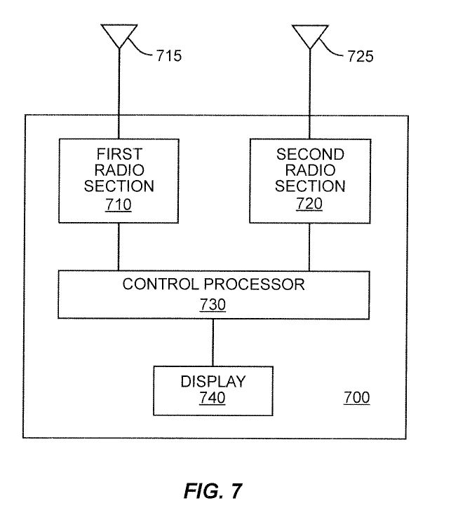

A block diagram illustrating exemplary functional components of a portable communications device 700 according to one or more embodiments of the invention is provided in FIG. 7. Those skilled in the art will recognize that the pictured mobile station 700 may comprise a mobile telephone, a personal digital assistance (PDA) device with mobile telephone capabilities, a laptop computer, or other device with wireless communication capabilities. Those skilled in the art will further appreciate that the pictured mobile station 700 may be configured to implement one or more of the methods described above, such as the methods pictured in FIGS. 4, 5, and 6, and variants thereof.

Mobile station 700 comprises a first radio section 710 and second radio section 720, connected to antennas 715 and 725, respectively. In the pictured embodiment, antennas 715 and 725 are illustrated as separate elements, although in some embodiments a single antenna structure may comprise multiple antenna elements for transmitting and receiving signals in two or more distinct frequency bands. The first radio section 710 comprises radio frequency circuitry, analog circuitry, and baseband processing logic configured according to one or more wireless telecommunication standards, such as GSM or UMTS. Accordingly, mobile station 700 may be operated on any compatible wide-area wireless network, as well as with a compatible femtocell base station. Second radio section 720 comprises receiver circuitry (and, in some cases, corresponding transmitter circuitry) for at least one additional radio signal type. Accordingly, radio section 720 may comprise a broadcast FM receiver, a wireless LAN transceiver, a Bluetooth transceiver, or the like.

The first and second radio sections 710 and 720 are controlled by control processor 730, which comprises one or more microprocessors, microcontrollers, digital signal processors, or the like, configured with software stored in a non-volatile memory (not shown) such as flash memory. In some embodiments of the invention, the control processor 730 is configured to extract site-specific services data from the wireless telecommunications signal received from a femtocell by the first radio section 710, and to control the second radio section 720 to access a second radio signal, using the site-specific services data. Thus, in embodiments where second radio section 720 comprises an FM radio receiver, control processor 730 may use tuning information (e.g., frequency information) included in the site-specific services data to tune the second radio section 720 to a low-power FM station operating in the vicinity of the femtocell. In other embodiments, radio section 720 may comprise a wireless LAN transceiver, a location beacon receiver, and/or a radio-navigation signal receiver (such as a GPS receiver), in which case the control processor 730 may use tuning information, channel identification information, synchronization information, or the like, extracted from the site-specific services data, to configure the second radio section 720 to access the corresponding signal or signals.

In some embodiments, the second radio signal may comprise a location beacon, in which case the control processor may be further configured to determine a position for the mobile station 700 using the location beacon. In some of these embodiments, the site-specific services data may include a color code for the location beacon and location data for the location beacon, in which case the control processor 730 may be configured to determine a position for the mobile station 700 by identifying the location beacon from two or more beacon signals using the color code. In some embodiments, control processor 730 is further configured to access a location beacon by searching for the beacon during one or more intervals synchronized to a characteristic cycle of the wireless telecommunications signal. In these embodiments, control processor 730 may use synchronization information or other timing information from the site-specific services data to determine the appropriate intervals for searching.

Control processor 730 may be further configured to decrypt at least a portion of the site-specific services data using a pre-determined decryption key. In some embodiments, the control processor is further configured to send a request for site-specific services data to the femtocell base station, and to process the site-specific services data transmitted in response to the requests. As was noted above, the request may in some embodiments specify a particular type of services data that is required, so that the femtocell can tailor its transmission accordingly.

Those skilled in the art will appreciate that the various functions of mobile station 700 may be implemented with customized or off-the-shelf hardware, general purpose or custom processors, or some combination. Accordingly, each of the described processing blocks may in some embodiments directly correspond to one or more commercially available or custom microprocessors, microcontrollers, or digital signal processors. In other embodiments, however, two or more functional elements of mobile station 700 may be implemented on a single processor, while functions of other blocks are split between two or more processors. One or more of the functional blocks pictured in FIG. 7 may also include one or more memory devices containing software, firmware, and data, including stored media data files, for processing multimedia in accordance with one or more embodiments of the present invention. Thus, these memory devices may include, but are not limited to, the following types of devices: cache, ROM, PROM, EPROM, EEPROM, flash, SRAM, and DRAM. Those skilled in the art will further appreciate that functional blocks and details not necessary for an understanding of an invention have been omitted from the drawings and discussion herein.

The present invention may, of course, be carried out in other specific ways than those set forth without departing from the scope of the inventive techniques illustrated by the specific embodiments illustrated herein. Thus, the present invention is not limited to the features and advantages detailed in the foregoing description, nor is it limited by the accompanying drawings. Indeed, the present invention is limited only by the following claims and their legal equivalents.

1. A femtocell base station, comprising:
a radio module configured for wireless communication with mobile stations according to at least one wireless telecommunication standard;
a data network interface module operative to provide a data connection between the radio module and a wide-area network, via a local broadband connection; and
a configuration module operative to store site-specific services data and to configure the radio module to broadcast the site-specific services data on a common channel to the mobile stations.

2. The femtocell base station of claim 1, wherein the site-specific services data comprises at least one of: radio signal data identifying one or more alternate radio signals; position data indicating a location of the femtocell base station; location assistance data for use by a mobile station in determining its position; and resource data identifying one or more physical resources in the vicinity of the femtocell base station.

3. The femtocell base station of claim 1, wherein the site-specific services data comprises beacon data identifying one or more location beacon signals.

4. The femtocell base station of claim 3, wherein the beacon data comprises color code information and corresponding position information for each of the one or more location beacon signals.

5. The femtocell base station of claim 1, wherein the configuration module is further operative to receive a request for site-specific services information from a first mobile station, via the radio module, and to configure the radio module to broadcast the site-specific services data responsive to said request.

6. A method for acquiring services information with a portable communications device, comprising:
receiving a wireless telecommunications signal broadcast by a femtocell base station;
extracting site-specific services data from the signal; and
accessing a second radio signal using the site-specific services data.

7. The method of claim 6, wherein the second radio signal comprises a location beacon, further comprising determining a position for the portable communications device using the location beacon.

8. The method of claim 7, wherein the site-specific services data includes a color code for the location beacon and location data for the location beacon, and wherein determining a position for the portable communications device using the location beacon comprises identifying the location beacon from two or more beacon signals using the color code.

9. The method of claim 7, wherein accessing the location beacon comprises searching for the location beacon during one or more intervals synchronized to a characteristic cycle of the wireless telecommunications signal.

10. The method of claim 9, wherein the characteristic cycle comprises a paging frame interval.

11. The method of claim 6, further comprising selecting the second radio signal from two or more radio signals identified by the site-specific services data.

12. The method of claim 11, wherein selecting the second radio signal comprises determining a priority value for each of the two or more radio signals based on prior attempts to access the two or more radio signals, and selecting the second radio signal based on the priority values.

13. The method of claim 6, further comprising sending a request for site-specific services data to the femtocell base station.

14. A portable communications device, comprising:
a first radio section configured to receive a wireless telecommunications signal broadcast by a femtocell base station;
a second radio section; and
a control processor configured to extract site-specific services data from the wireless telecommunications signal and to control the second radio section to access a second radio signal, using the site-specific services data.

15. The portable communications device of claim 14, wherein the second radio signal comprises one of a low-power FM radio signal, a wireless local-area network signal; a location beacon; and a radio-navigation signal.

16. The portable communications device of claim 14, wherein the second radio signal comprises a location beacon, and wherein the control processor is further configured to determine a position for the portable communications device using the location beacon.

17. The portable communications device of claim 16, wherein the site-specific services data includes a color code for the location beacon and location data for the location beacon, wherein the control processor is configured to determine a position for the portable communications device by identifying the location beacon from two or more beacon signals using the color code.

18. The portable communications device of claim 16, wherein the control processor is configured to access the location beacon by searching for the location beacon during one or more intervals synchronized to a characteristic cycle of the wireless telecommunications signal.

19. The portable communications device of claim 14, wherein the control processor is configured to select the second radio signal from two or more radio signals identified by the site-specific services data.

20. The portable communications device of claim 19, wherein the control processor is configured to select the second radio signal by determining a priority value for each of the two or more radio signals, based on prior attempts to access the two or more radio signals, and selecting the second radio signal based on the priority values.
